(19) United States
(12) Patent Application Publication
(10) Pub. No.: US 2025/0383718 A1
(43) Pub. Date: Dec. 18, 2025

(54) INFORMATION PROCESSING APPARATUS, INFORMATION PROCESSING METHOD, AND NON-TRANSITORY STORAGE MEDIA

(71) Applicant: TOYOTA JIDOSHA KABUSHIKI KAISHA, Toyota-shi (JP)

(72) Inventors: Koichi SUZUKI, Miyoshi-shi (JP); Tadahiro KASHIWAI, Nagoya-shi (JP); Kazuya OKADA, Tokyo (JP); Naoya KANEKO, Tokyo (JP); Hiroto NAKAGAWA, Nagoya-shi (JP)

(73) Assignee: TOYOTA JIDOSHA KABUSHIKI KAISHA, Toyota-shi (JP)

(21) Appl. No.: 19/233,762

(22) Filed: Jun. 10, 2025

(30) Foreign Application Priority Data
Jun. 13, 2024 (JP) 2024-096044

(51) Int. Cl. G06F 3/01; G01C 21/36; G06F 3/04847

(52) U.S. Cl. CPC G06F 3/017; G01C 21/3664; G06F 3/04847

(57) ABSTRACT

A controller transmits, based on a command by a gesture of a user acquired via a user device, information about a target facility specified in a video captured by the user device, to the user device, or an output device existing in a predetermined range from the position of the user device. The target facility is specified based on the state of the user in the three-dimensional space or the state, in the three-dimensional space, of the user device moving with the user.

### CROSS REFERENCE TO THE RELATED APPLICATION

This application claims the benefit of Japanese Patent Application No. 2024-096044, filed on Jun. 13, 2024, which is hereby incorporated by reference herein in its entirety.

### BACKGROUND

### Technical Field

The present disclosure relates to an information processing apparatus, information processing method, and a non-transitory storage media.

### Description of Related Art

As a conventional user interface, it is disclosed that the user's gesture is recognized from the first and second images, and an interaction command corresponding to the recognized user's gesture is determined (for example, Patent Literature 1 below). In addition, it is disclosed that based on the determined interaction command, an image object displayed in the user interface, is manipulated.

### CITATION LIST

### Patent Literature

Patent Literature 1: Japanese Patent Laid-Open No. 2011-527357

### SUMMARY

However, merely manipulating image objects, such as, by zooming in and out, is not enough to clearly show the details of various objects contained in the image. An aspect of an embodiment of the present disclosure is to provide details about an object visually recognized by a user in response to a simple operation by the user.

In one aspect, an embodiment of the disclosure is exemplified by an information processing apparatus comprising a controller. The controller configured to: transmit, based on a command by a gesture of a user acquired via a user device, information about a target facility specified in a video captured by the user device, to the user device, or an output device existing in a predetermined range from a position of the user device, the target facility being specified based on the state of the user in the three-dimensional space or the state, in the three-dimensional space, of the user device moving with the user.

The information processing apparatus can provide details about an object visually recognized by the user in response to the simple operation by the user.

### BRIEF DESCRIPTION OF THE DRAWINGS

FIG. 1 is a diagram illustrating an example of an information system of one embodiment.

FIG. 2 is a diagram illustrating components constituting a fifth-generation mobile communication system.

FIG. 3 is a sequence diagram illustrating an example of a process in information system.

FIG. 4 is a flowchart that indicates an example of a process of a server.

FIG. 5 is a flowchart that indicates an example of a process of sensing and providing information.

### DESCRIPTION OF THE EMBODIMENTS

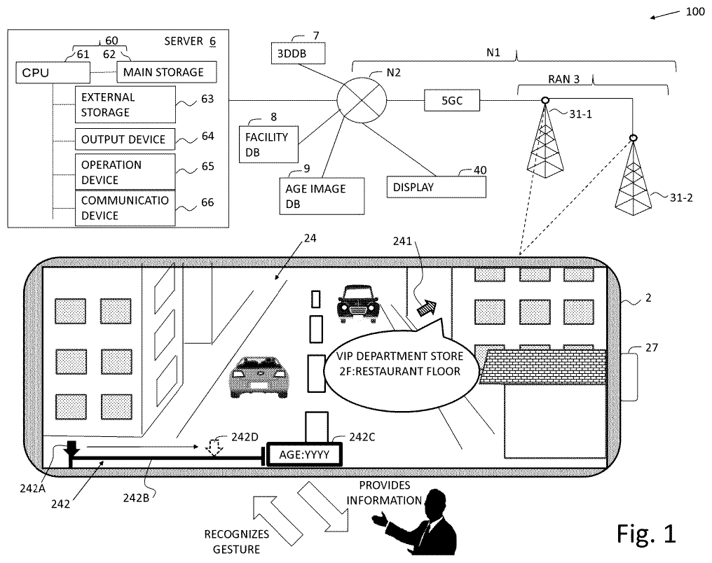

Referring to the drawing below, embodiment of an information processing apparatus, information processing method and a program will be described. The information processing apparatus is exemplified by a server 6 of FIG. 1. The information processing apparatus comprises a controller 60. A UE 2 is a user device that moves with a user. Based on the state of the user in the three-dimensional space or the state of the UE 2 in the three-dimensional space, the controller 60 specifies the target facility in a video captured by the camera 27 of the UE 2. Further, the controller 60 acquires information related to the target facility specified in the video. The display 40 is an output device that exists within a predetermined range from the position of the UE 2. Then, the controller 60 transmits information about the target facility to the UE 2 or the display 40 based on a command by the user gesture acquired via the UE 2.

### (System Configuration and Application Examples)

FIG. 1 is a diagram illustrating an information system 100 of the present embodiment. The information system 100 includes User Equipment (hereinafter referred to as the UE 2), a server 6, a three-dimensional dynamic map database (hereinafter referred to as 3DDB 7), a facility database (hereinafter referred to as the facility DB 8), an age image database (hereinafter referred to as the age image DB 9), and a display 40. The UE 2, the server 6, the 3DDB7, the facility DB 8, the age image DB 9, and the display 40 are connected by the network N1.

A network N1 includes a wireless network and a wired network N2. That is, the network N1 includes, for example, a mobile communication system such as LTE (Long Term Evolution), a fifth-generation mobile communication system (5G), and a sixth-generation mobile communication system (6G), and a wireless LAN (Local Area Network), and the like. Further, the network N1 includes a public network such as the Internet. In FIG. 1, 5G Core (5GC) and a radio access network (hereinafter referred to as RAN 3) are illustrated as mobile communication systems.

The server 6 is a computer. However, the server 6 may be referred to as Mobile Edge Computing or Multi-access Edge Computing (MEC) server. In the present embodiment, the server 6 works with UE 2 to provide an environment such as Augmented Reality (AR), Mixed Reality (MR), Virtual Reality (VR), and other Extended Reality/Cross Reality (XR).

The server 6 includes a central processing unit (hereinafter referred to as CPU 61), a main storage 62, and an external device, and executes information processing and communication processing by a computer program. The CPU 61 is also referred to as a processor. The CPU 61 is not limited to a single processor and may be a multiprocessor configuration. Further, the CPU 61 may include a graphics processing unit (GPU), a digital signal processor (DSP), and the like.

The CPU 61 executes an executable computer program deployed to the main storage 62 and provides processing for the server 6. The main storage 62 stores a computer program executed by the CPU 61, data processed by the CPU 61, and the like. The CPU 61 and the main storage 62 are referred to as the controller 60.

Examples of the external device include an external storage 63, an output device 64, an operating device 65, and a communication device 66. The external storage device 63 is used, for example, as a storage area to assist the main storage 62, and stores a computer program executed by the CPU 61, data processed by the CPU 61, and the like.

The output device 64 is, for example, a display device such as a liquid crystal display or an electroluminescent panel. However, the output device 64 may include a speaker or other device that outputs a sound. The operation device 65 is, for example, a touch panel in which a touch sensor is superimposed on a display. The communication device 66 accesses network N1 and the like, and communicates with a computer or the like connected to network N1 or the like.

However, the server 6 is not limited to a single computer as exemplified in FIG. 1. The server 6 may be configured in which a plurality of computers are linked by a network N1 or the like. The sever 6 may be a system that executes processing by virtualized resources. The server 6 may be, for example, a system in a cloud environment.

The 3DDB 7 includes a dynamic map and provides information about features in a three-dimensional space including roads. The hardware configuration of the 3DDB 7 is the same as that of the server 6, and includes a CPU, a memory, an external storage, a communication device, and the like. However, the 3DDB 7 may be provided in a cloud environment by a virtual resource on the network.

A dynamic map is defined as high-precision three-dimensional geospatial information (basic map information) that can identify the position of the vehicle on the road and its surroundings at the lane level, and various additional map information necessary to support autonomous driving, etc. on it. Here, the additional map information is defined as, for example, traffic regulation information including dynamic information such as accident and construction information, in addition to static information such as speed limits (Public-Private ITS Concept and Roadmap 2016, Advanced Information and Communication Network Society Promotion Strategy Headquarters).

Dynamic maps include static data and dynamic data. Static data is called high-precision three-dimensional map data. High-precision 3D map data is a 3D map that covers the details of the road surface and lanes information, and the position information of structures. The high-precision three-dimensional map data includes road section identification information (ID), marker points, latitude and longitude as position reference data. Further, the high-precision three-dimensional map data includes data of a feature that actually exists in association with the position reference data. Features include, for example, shoulder edges, lot lines, stop lines, pedestrian crossings, traffic lights, level crossings, buildings. Further, the high-precision three-dimensional map data includes an image captured by a camera or three-dimensional data created by a three-dimensional laser scanner or the like in association with position information by a global navigation satellite system (GNSS) or a global positioning system (GPS).

Therefore, by collating the position information of UE 2 and the image taken by the UE 2 at the position specified by the position information with the information of the 3DDB 7, the server 6 can specify the geographical location corresponding to the three-dimensional position on the image. The dynamic data includes, for example, pedestrian information, accident information, traffic jam information, and the like.

The facility DB 8 provides information about the facility at a geographic location. The hardware configuration of the facility DB 8 is the same as that of the server 6 or the 3DDB 7. Each data (also referred to as a record) in the facility DB 8 includes latitude, longitude, name of the facility, and information of the facility. The facility information includes, for example, summary information and detailed information. Therefore, by specifying each position (latitude and longitude) in the image captured by UE 2, the server 6 can obtain the name, summary information, and detailed information of the facility of the latitude and longitude location from the facility DB 8.

The age image DB 9 stores an image of a past point in time in the landscape including each facility registered in the facility DB 8 in association with time point information indicating a past point in time. There is no limitation to the past point in time. The server 6 receives information indicate a position (latitude and longitude, etc.) and a request specifying a past point from UE2. According to the information and the request received from the UE 2, the server 6 acquires a view image at a past point including a facility existing at the position from the age image DB 9. The server 6 transmits the view image acquired from the age image DB 9 to the UE 2.

The display 40 is an example of an output device and is one of the large display devices installed in the area where the UE 2 moves. The display 40 may be a projector that projects an video on a wall of a building or the like. The geographical location (latitude, longitude, etc.) at which the display 40 is installed or the geographical location such as a building on which the video is projected is registered and stored on the server 6 or the facility DB 8.

The UE 2 is, for example, an in-vehicle device called In-Vehicle Infotainment (IVI), a smartphone, or the like. The UE 2 may be an information processing apparatus comprising a spectacled-like head-mounted display (HMD) called smart glasses or AR glasses that can access the network. UE2 may be called a VR terminal. The UE 2 may also be a combination of a headset and a display, including headphones and a microphone.

The UE 2 provides information and entertainment to the user by being carried by the user inside the vehicle or outside the vehicle. The hardware configuration of UE2 is logically similar to server 6, although there are differences in shape, scale, and size. In FIG. 1, an example shows a camera 27 and a display 24 fitted into the housing, of the UE 2.

The UE 2 displays information obtained by fusing virtual information with a real three-dimensional space video captured by the camera 27 on the display 24. The UE 2 may display information on the display 24, and also output sound through the speaker. The camera 27 includes a rear camera that captures the user line of sight (the rear direction of the display 24) and a face-to-face camera that captures the user himself (from the surface of the display 24 to the user). The display 24 in FIG. FIG. 1 shows an video captured by the rear camera of the camera 27. When the UE 2 is an in-vehicle device, the camera 27 includes a front camera that captures the front of the vehicle in the direction of travel, a right camera that shoots the right side, a rear camera that shoots the rear, and a left camera that captures the left side.

Further, the UE 2 arranges a position pointer 241 and a time pointer 242 in the video displayed on the display 24. The UE 2 acquires information on the facility existing at the point indicated by the position pointer 241 from the server 6 and displays it in the video. In the example of FIG. 1, “VIP Department Store” is displayed as the facility name in the vicinity of the position pointer 241, and information “2F: Restaurant floor” is displayed. More specifically, the UE2 provides the server 6 with the video captured by the camera 27 together with the current position information of the UE 2. Thereby, the UE 2 requests the server 6 to specify the position where the position pointer 241 is placed and to provide information on the facility existing at the specified position.

Based on the position information provided by the UE 2, the server 6 acquires dynamic map data of 3DBD 7 or high-precision three-dimensional map data. Then, the server 6 collates the video provided by the UE 2 and the data of 3DBD 7 and specifies the position and orientation of the video provided by the UE 2. Then, the server 6 specifies the latitude and longitude of the position where the position pointer 241 exists in the video.

Then, the server 6 acquires information on the facility existing at the position where the position pointer 241 exists from the facility DB 8. The server 6 transmits the facility information thus obtained to the UE 2. The UE2 performs XR display by adding a virtual image formed based on the facility information transmitted from the server 6 to the video captured by the camera 27.

However, the server 6 may display information, of the facility existing at the position where the position pointer 241 is located in the video displayed by the UE 2, on the external display 40 with or instead of the UE2. The server 6 may select a display 40 existing in a predetermined range from the position of the UE 2 and display information on the facility. Here, the predetermined range may be set on the server 6 or may be specified in a parameter received from the user via UE 2.

The time pointer 242 includes a cursor 242A, a slide bar 242B, and an era display column 242C. The time pointer 242 accepts an operation to change the time of year of the view, including the facility identified by the position pointer 241. For example, when the cursor 242A is at the left end of the slide bar 242B, the UE 2 displays the current video captured by the camera 27 on the display 24. When the user shifts the cursor 242A to another position 242D other than the left edge of the slide bar 242B, the UE 2 goes back in time and identifies the corresponding year. The corresponding year is displayed in the era display column 242C as a four-digit year YYYY. Then, the UE 2 displays on the display UE 2 a video of a view including a facility identified by the position pointer 241, and a video of a date close to the year specified by the time pointer 242.

More specifically, the UE 2 transmits the identification information of the year and facility identified by the time pointer 242 to the server 6 and requests the transmission of a video of the past view. Then, the server 6 refers to the age image DB9, acquires the video of the closest age to the year with a video including a facility specified by the identification information, and transmits it to the UE 2. The UE 2 displays the age video transmitted from the server 6. The video of the age image DB 9 includes still images and moving images.

Further, in the present embodiment, the UE 2 and the server 6 work together to identify the user's gesture from the image taken of the user, and recognize the command issued by the user based on the gesture. The UE 2 and the server 6 provide the user with information corresponding to command corresponding to the gesture.

Additionally, there are no limitations on the division of tasks between the processing of the UE 2 and that of the server 6. For example, without going through the processing of the server 6, the UE 2 recognizes the user gesture, acquires information from 3DDB 7, the facility DB 8, and the age image DB 9, and displays it on the display 24. Further, the UE 2 may simply function as a display device equipped with a program such as a browser. In that case, the server 6 recognizes the user gesture, acquires information from 3DDB 7, the facility DB 8, and the age image DB 9, and displays it on the UE 2 display 24 via a browser.

The server 6 acquires information about the state of the UE2 or the state of the user moving with the UE2 acquired by the 5GC including the base stations 31-1 and 31-UE 2 via 5GC. The 5GC including the base stations 31-1 and 31-2 specifies the position of the UE 2 when exchanging and receiving signaling messages with the UE 2. The base stations 31-1 and 31-2 may detect, for example, the angle of the transmission beam (or reception beam) used during signaling. Then, the 5GC extends a straight line corresponding to the transmission beam (or reception beam) from the positions of the base stations 31-1 and 31-2, and the position of the intersection of these straight lines is the position of UE 2. Then, the 5GC applies the principle of triangulation from the positional relationship between the base stations 31-1 and 31-2 and the UE 2, and measures the distance from the base stations 31-1 and 31-2 to the UE 2, the geographical position (latitude, longitude) of the UE 2, and the like. Further, from the change in the position of the UE 2 over time, the 5GC specifies the movement speed and movement direction of the UE 2. Further, from the change in the movement speed of the UE 2 over time, the 5GC identifies the acceleration of the UE 2.

Further, the 5GC may use the downlink transmission wave from the base station 31-1 or the base station 31-2 in the same principle as the radar. That is, the 5GC measures the distance to the UE2, the current geographical position (latitude, longitude) of the UE2, the movement speed, the direction of movement, acceleration, and the like based on the reflected wave reflected from the user whose transmission wave moves with the UE2 or the user moving with the UE2. The base stations 31-1, 31-2, and the like may be used in combination with measurement by a signaling message and measurement by a reflected wave. For example, the base stations 31-1, 31-2, etc. may roughly identify the position of the UE 2 by a signaling message, and measure the position of the UE 2 from the reflection on the transmitted wave by improving the accuracy in real time. The server 6 acquires information related to the position or movement of the UE 2 as described above from the 5GC. The base stations 31-1, 31-2, and the like are collectively referred to as base stations 31.

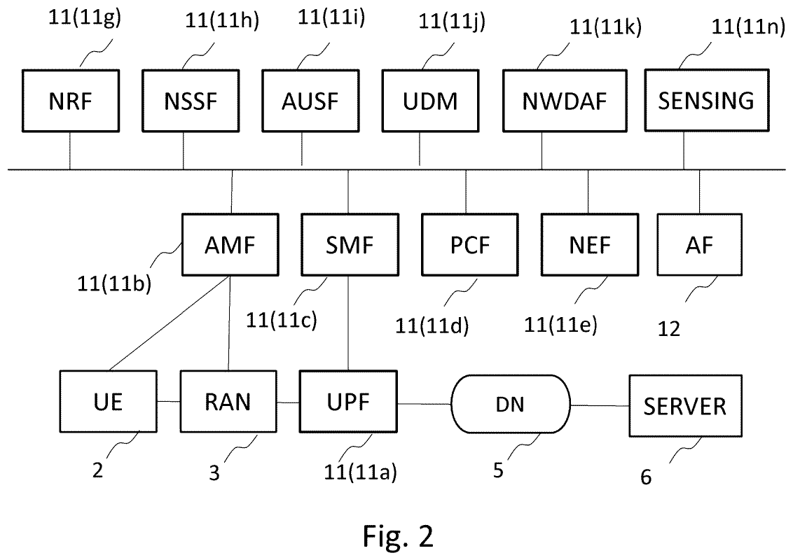

Further, the server 6 acquires from UE2 the state of UE 2 or the state of the user moving, detected by the UE 2, with UE2 by communicating with the UE 2. The state of the UE 2 is, for example, the position, the movement speed, the direction of movement, the acceleration, the direction of the visual axis of the camera 27 of the UE 2, and the like. The state of the user is, for example, an image in which the user was photographed, the direction of the user's line of sight obtained from the image, the gesture of the user, the command of the user specified from the gesture, and the like. Further, the server 6 acquires the state of the UE 2 or the state of the user acquired by 5GC from 5GC. For example, a network function (NF11) such as NWDAF11k, SENSING11n (see FIG. FIG. 2) of 5GC acquires the state of the UE 2 or the state of the user from the UE 2. The NWDAF 11k, SENSING 11n, and the like of the 5GC provide the server 6 with information on the acquired the UE 2 state or the user state.

### (XR Display and Gesture Examples)

Hereinafter, an example of a user gesture recognized by the server 6 is shown. Here, it is described as if the server 6 recognizes the gesture. However, as already mentioned, the UE 2 may recognize the user command from the user gesture. Further, the UE 2 may notify the server 6 of the recognized user command via the NWDAF11k, SENSING11n, or the like of the 5GC. Alternatively, the UE2 may directly notify the server 6 of the recognized user command.

(1) The position pointer specifies, in the video captured by the camera 27, a position in space including depth based on the position information of the UE 2 and the direction of the visual axis facing the camera 27. The server 6 (control unit 60) initially sets a facility in the vicinity of the position pointer 241 as the first facility. At this time, the UE2 may confirm that the direction of the user's line of sight coincides with the direction of the visual axis of the camera 27 within a predetermined permitted range. Thus, the UE 2 and the server 6 can confirm that the video matches that of the user field of vision. The server 6 transmits information about the initially configured first facility to the UE 2. The UE2 generates a virtual image element such as a graphic object based on the information transmitted from the server 6, and displays it XR together with the video captured by the camera 27.

(2) When the gesture is a back-and-forth movement of the hand, the server 6 links the front and back movement of the hand with the movement in the perspective direction in the user's field of view, and moves the position pointer 241 on the display 24 of UE2. Note that the gesture may be a hand gesture. Further, the hand gesture is a sign indicate the front and back of the user, and may be a sign stationary for a predetermined time. The server 6 may move the position pointer 241 in the direction of the sign at that predetermined time. Then, the server 6 compares the video captured by the camera 27 of the 3DDB 7 and the UE 2, and specifies the latitude and longitude of the real space corresponding to the position pointer 241 in the three-dimensional space in the video. Then, the server 6 identifies other facilities existing in the vicinity of the moved position pointer 241 from the facility DB 8, and sets the specified other facilities as a second facility. Then, the server 6 transmits information about the configured second facility to the UE 2. The UE 2 XR displays information about other facilities as the second facility.

(3) If the gesture is a gesture to push the hand forward of the user, the server 6 moves the position pointer 241 farther away in the user field of vision. Here, the server 6 may execute processing, for example, with the direction of the visual axis of the camera 27 as the far direction of the user field of view. Then, the server 6 transmits information about the second facility that exists farther away than the first facility to the UE2 in the same procedure as in (2) above.

(4) If the gesture is a gesture of pulling from the user extended hand, the server 6 moves the position pointer 241 closer to the user field of vision. Here, for example, the server 6 may perform processing in the direction opposite to the direction of the visual axis of the camera 27 (the face-to-face direction toward the user) as the direction near the user field of view. Then, the server 6 transmits information about the second facility existing closer than the first facility to the UE2 in the same procedure as in (2) above.

(5) The time pointer 242 can be moved on the time axis and specifies the present or a past time that is retrochronous from the present. The server 6 set initial value of the time pointer 242 to the current. Then, if the gesture is an up and down movement of the hand, the server 6 moves the time pointer 242 in conjunction with the up and down movement of the hand and the present or the past time going back from the present. Note that the gesture may be a hand gesture. Further, the hand gesture is a sign indicating the top or bottom of the user, and may be a sign stationary for a predetermined time. The server 6 may move the time pointer 242 in the direction of the sign at that predetermined time. The server 6 then transmits to the UE 2 a video of the view including the first facility or the second facility in the present or past period going back from the present, indicated by the time pointer 242.

(6) If the gesture is a gesture to move the hand, for example, downward, the server 6 moves the time pointer 242 to a predetermined time in the past. Further, the server 6 transmits to the UE 2 an video of the view including the first facility or the second facility at a time retroactively from the present to a predetermined time past. Further, when the gesture is a gesture to move the hand, for example, in the upward direction, the time pointer 242 is moved closer to the present by the time corresponding to the gesture. Then, the server 6 transmits to the UE 2 a video of the view including the first facility or the second facility at a time advanced from the period before the gesture for a time corresponding to the gesture.

(7) If the gesture is a hand holding gesture, the server 6 transmits and displays detailed information about the first facility or the second facility to UE2 with an increased amount of information. Further, when the gesture is a gesture that spreads from the state of holding the hand, the server 6 transmits and displays summary information obtained by reducing the amount of information related to the first facility or the second facility to the UE 2.

(8) If the gesture is a gesture to pay the hand, the server 6 transmits information about the first facility or the third facility that is obstructed by the second facility and cannot be seen in the user's line of sight to the UE 2.

The above processes (1) to (8) are examples of processing based on the state of the user in the three-dimensional space (position, posture, line of sight, movement, etc.) or the state of the UE 2 that moves with the user, in the three-dimensional space (position, movement, orientation, attitude, line of sight, field of view, visual axis, angle of view, position of the pointer, etc.). Further, such a process is an example of a process based on a command by a user gesture acquired via the UE 2. Then, by this process, the server 6 transmits information about the target facility specified in the video captured by the UE 2 to the display 40, which is an output device that exists within a predetermined range from the position of the UE 2 or the UE 2.

### (Network Example)

FIG. 2 illustrates components (components) constituting a fifth-generation mobile communication system (also referred to as a 5G network or 5GNW) in the network N1. Here, in the present embodiment, the components of 5GC are collectively referred to as Network Function (hereinafter referred to as NF11), and individually referred to as NEF11e and the like. In FIG. 1, each component is given a generic reference numeral as well as an individual reference numeral in parentheses. Among the components of FIG. 2, configurations other than SENSING 11n are defined, for example, in 3GPP (Registered Trademark) TS23.501, and the description thereof is omitted. DN5 is a data network (Internet, etc.) outside 5GC. To the DN 5, for example, the server 6 is connected. The server 6 may be 5GC AF12. The RAN (Radio Access Network) 3 is an access network to the 5G core network (5GC). The RAN 3 is configured by a base station 31 (gNB).

The SENSING 11n performs a sensing process including collecting sensing information from the UE2 or other external system and providing the collected sensing information to the UE2, AF12, or other external system (DN5 or the like). However, instead of the SENSING 11n, the NWDAF 11k may perform the sensing process. In the following embodiment, the SENSING 11n will be described as performing the sensing process. pointer 241 in the video displayed by the UE 2 with or instead of the UE 2 on the external display 40. The processing of S34 is an example of transmitting information about the target facility to an output device existing within a predetermined range from the location of the UE 2 or the UE 2 based on a command by a user's gesture obtained via the UE 2.

### (Processing Procedure)

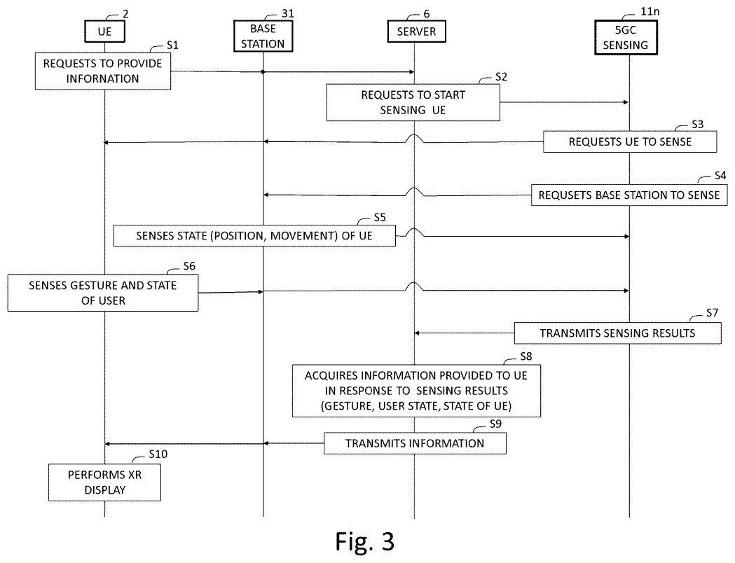

FIG. 3 is a sequence diagram illustrating a process in the information system 100. In this process, first, the UE 2 requests the server 6 to provide information (S1). In response to a request from UE2, the server 6 requests SENSING11n, which is one of the NF11 of 5GC, to start sensing the UE2 (S2).

When the SENSING 11n receives a request to start sensing, the SENSING 11n requests UE2 via the base station 31 to sense the user's gesture and the user's state (S3). At this time, the SENSING 11n requests the base station 31 to sense the UE 2 (S4).

When the base station 31 receives a request to sense the UE 2, it senses the state of the UE 2. Here, the base station 31 includes both the base stations 31-1 and 31-2. For example, during signaling, the base station 31 measures the state of the UE2, such as the distance to the UE2, the current geographic position (latitude, longitude), the movement speed, the direction of movement, acceleration, etc., in the manner described in FIG. Further, the base station 31 measures the state of the UE 2 from the reflected wave with respect to the downlink transmission wave, for example. Then, the base station 31 reports the sensing results to the SENSING 11n (S5).

On the other hand, when the UE 2 receives a sensing request, the user is captured by the camera 27 and the captured video is transmitted to the SENSING 11 via the base station 31 (S6). However, the UE 2 recognizes the user command by analyzing the user line of sight and the user gesture from the captured video. Further, the UE 2 may transmit the recognized user line of sight direction and the user command to the SENSING 11. Also, at this time, UE 2 is the current geographical position (latitude, longitude), speed, direction of movement, acceleration, camera 27's visual axis the orientation and the like may be transmitted to the SENSING 11.

When the SENSING 11n receives the sensing results from the base station 31 and the UE2, the sensing results is transmitted to the server 6 (S7). In S6, when UE 2 transmits a user image, the SENSING 11n analyzes the user's line of sight or gesture from the video received from the UE 2, and recognizes the direction of the line of sight or the user's command.

The server 6 receives the sensing results from the SENSING 11n, that is, the user command by gesture, the state of the user, the state of the UE2, and the like. Then, in response to the acquired user command, the user state, the state of UE2, and the like, the server 6 acquires information provided to UE2 (S8). That is, the server 6 executes, for example, the processes of (1) to (8) above. Then, the server 6 transmits the acquired information to the UE 2 (S9).

The UE 2 performs XR display based on information transmitted from server 6. That is, corresponds to the gesture of the user, the UE 2 taken with camera 27I in the video, move position pointer 241. Then, the UE 2 represents the information of the facility identified by position pointer 241 (S10). In addition, the UE 2 changes the amount of information displayed for the facility in response to the gesture of the user. For example, UE2 displays detailed or summary information about the facility in response to the gesture of the user. In the processing of S9, the server 6 may transmit the acquired information to the display 40 together with the UE2 or instead of the UE2 and display it. In that case, the server 6 may perform XR display on the display 40 based on the video captured by UE2 and the acquired information.

Further, UE 2 changes the timing indicate by the time pointer 242 in response to the user gesture. The UE 2 then displays a video of the view including the facility at the current or past point in time, corresponding to the time indicated by the time pointer 242. The UE 2 also displays information on other facilities hidden behind the facility identified by the point pointer 241 in response to the user's gesture.

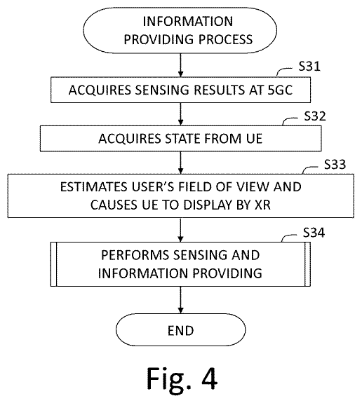

FIG. 4 is a flowchart that indicates an example of the process of the server 6. In this process, the server 6 acquires the sensing results at 5GC (S31). Next, the server 6 acquires information about the state of the UE 2 directly from the UE 2 (S32). Note that the server 6 may omit either the process of S31 or the process of S32.

Next, the server 6 estimates the user's field of view based on the information obtained in the process of S31 or the process of S32, adds virtual information to the actual three-dimensional space video in the display 24 of the UE 2, and causes the UE 2 to perform the display by XR (S33). At this time, the position pointer 241 and the time pointer 242 are also displayed in the display by XR. For example, the position pointer 241 specifies a position in the three-dimensional space including the depth in the video captured by the camera 27 based on the direction of the visual axis of the camera 27 connected to the UE 2 and the position information of the UE 2. Then, the server 6 may initially set a facility near the position pointer 241 as the first facility. Since the facility near the point pointer is subject to processing by the server 6, it can be referred to as a target facility. And the process of S33 is also an example of sending information about the initially configured first target facility to the UE 2. Note that the time pointer 242 can move on the time axis and specifying the present or a past time that has been moved back in time from the present. Then, in the process of S33, the server 6 may set the initial value of a time pointer 242 to the present.

Then, the server 6 performs sensing and information provision (S34). In the S34 process, the server 6 acquires the state of the UE 2, the state of the user moving with the UE 2, and the gesture of the user, either via 5GC or directly from the UE 2. Then, in response to the gesture of the user, the server 6 causes the UE 2 to display XR on the video captured by the camera 27 of the UE 2.

However, as described in FIG. 1, the server 6 may display facility information identified by the position pointer 241 in the video displayed by the UE 2 with or instead of UE 2 on the external display 40. The processing of S34 is an example of transmitting information about the target facility to an output device existing within a predetermined range from the location of the UE 2 or the UE 2 based on a command by a user's gesture obtained via the UE 2.

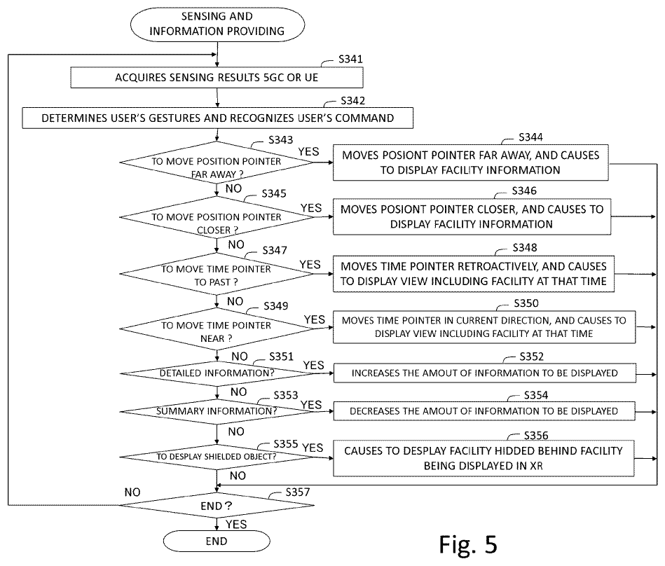

FIG. 5 is a flowchart illustrating sensing and information provision processing (details of S34 in FIG. 4). In this process, the server 6 acquires the sensing results of the SENSING 11n or UE 2 of the 5GC (S341). Note that the server 6 may acquire the sensing results from the SENSING 11n of the 5GC, or may acquire it from the UE 2 without going through the SENSING 11n. Further, the server 6 may acquire sensing results from both the SENSING 11n and the UE 2 of the 5GC.

Next, the server 6 determines the user's gestures (S342). However, the UE 2 may recognize the user's command by analyzing the user's gesture. The server 6 may also receive the recognized command via the SENSING 11n or directly from the UE 2. Then, the server 6 determines the command by the gesture and executes the process according to the command (S343 to S356).

That is, if the command is to move the position pointer 241 far away (YES in S343), the server 6 moves the position pointer 241 in the video from the current position in the visual axis direction of the camera 27 far away. Then, the server 6 causes the UE 2 to display the facility information specified by the position pointer 241 in XR (S344). Furthermore, if the command is to move the position pointer 241 closer (YES in S345), the server 6 moves the position pointer 241 in the video from the current position closer (towards the user) in the visual axis direction of the camera 27. Then, the server 6 causes the UE 2 to display the facility information specified by the position pointer 241 in XR (S346).

The case of YES in S343 and S345 is an example of a case where the gesture is a hand movement in a three-dimensional space corresponding to the depth direction in the video. The hand movement includes in the case of hand movements, as well as in the case of stationary finger signs. Then, in the case of YES in S343 and S345, the server 6 makes the movement of the hand in the depth direction corresponds to the movement in the perspective direction in the video. That is, the server 6 moves the position pointer 241 to a distant or near location in the video. Further, the server 6 sets another facility near the moved position pointer 241 as a second target facility. Then, the server 6 causes the above information to display on the display 40 existing in a predetermined range from the UE 2 or the UE 2.

Therefore, the processes of S344 and S346 are also an example of transmitting information about the set a second facility to the UE 2 or an output device that is present within a predetermined range from the position of the UE 2.

Further, if the command is to move the time pointer 242 to the past (YES in S347), the server 6 moves the time pointer 242 retroactively (S348) and causes the UE 2 to display the view including the facility at that time (S348). If the command is to move the time pointer 242 near, i.e., in the current direction (YES in S349), the server 6 moves the time pointer 242 in the current direction and causes the UE 2 to display the view including the facility at that time (S350).

If the answer is YES in S347 and S349, this is an example of the server 6 moving the time pointer 242 to the present or past time in response to the gesture. The processing of S348 and S350 is an example in which the server 6 transmits an image of the view including the first facility or the second facility at the current or past time indicated by the time pointer 242 from the position of UE2 or UE2 to a display 40 existing in a predetermined range.

Further, if the command is to increase the display information, that is, to display detailed information (YES in S351), the server 6 increases the amount of information to be displayed (S352). If the command is to reduce the display information, that is, to display the summary information (YES in S353), the server 6 reduces the amount of information to be displayed (S354). Furthermore, if the command is to display the shielded object, i.e., to display other facilities hidden behind the facility currently being displayed XR (YES in S355), the server 6 causes to display the facility hidden behind the facility being displayed in XR (S356). Then, the server 6 determines whether or not to terminate the process (S357). For example, when the UE 2 receives the end of processing from the user, the server 6 terminates the process. If the server 6 does not terminate the process, the process repeats from S341.

### (Embodiment Effect)

The server 6 acquires the state of the user in a three-dimensional space or the state of the UE 2 moving together with the user in a three-dimensional space. Then, based on these acquired states, the server 6 transmits information about the target facility specified in the video captured by the camera 27 of the UE2 to the display 40 existing in the predetermined range from the position of the UE 2 or the UE 2. In that case, the server 6 transmits information about the target facility based on a command that is information recognized from the user's gesture acquired via the UE 2. Thus, the server 6 can provide details about the object viewed by the user to the UE 2 in response to the user's simple operation.

Further, the server 6 moves the position pointer 241 by corresponding to the user's hand movement in the perspective direction in the video. Then, the server 6 sets another facility existing near the moved position pointer 241 as the second target facility. The server 6 then transmits information about the set second facility to the display 40, which is an output device that exists within a predetermined range from the location of the UE2 or the UE 2. Therefore, the server 6 can change the target facility to be displayed in XR in response to a simple operation by the user.

Further, the server 6 transmits an image of the view including the first facility or the second facility at the present or past time indicated by the time pointer 242 to a display 40 existing in a predetermined range from the position of the UE 2 or the UE 2. For this reason, the server 6 can display a temporal change in the view including the target facility on the UE 2 or the display 40 in response to a simple operation by the user.

### OTHER EMBODIMENTS

The above embodiment is only an example, and present disclosure may be appropriately changed and implemented within the scope of not deviating from the gist. In addition, the processes and means described in present disclosure can be freely combined and implemented as long as no technical contradiction arises. Further, the process described as being performed by one device may be performed by a plurality of devices. Alternatively, the processing described as performed by different devices may be performed by one device. In a computer system, the hardware configuration (server configuration) by which each function is implemented can be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMS, EEPROMs, magnetic cards, flash memories, or optical cards.

What is claimed is:

1. An information processing apparatus comprising a controller configured to:
transmit, based on a command by a gesture of a user acquired via a user device, information about a target facility specified in a video captured by the user device, to the user device, or an output device existing in a predetermined range from a position of the user device, the target facility being specified based on the state of the user in the three-dimensional space or the state, in the three-dimensional space, of the user device moving with the user.

2. The information processing apparatus according to claim 1, wherein the controller is further configured to:
initially set a facility near a position pointer as a first target facility, the position pointer specifying, in the video, the position in the three-dimensional space including the depth, based on the direction of the visual axis of the camera connected to the user device or the direction of the user line of sight and the position information of the user device,
transmit information related to the initially set first target facility to the user device,
when the gesture in the three-dimensional space is a hand movement in the direction corresponding to the depth direction in the video, move the position pointer in the perspective direction in the video corresponding to the hand movement,
set another facility existing near the moved position pointer as a second target facility, and
transmit information related to the set second target facility to the user device, or the output device existing in the predetermined range from the position of the user device.

3. The information processing apparatus according to claim 2, wherein the controller is further configured to:
set the initial value of a time pointer to the present, the time pointer being able to move on the time axis and specifying the present or a past time that has been moved back in time from the present,
move the time pointer to the present or the past time depending on the gesture, and
transmit an image of a view including the first target facility or the second target facility in the present or the past time indicate by the time pointer, to the user device, or the output device existing in the predetermined range from the position of the user.

4. An information processing method in which a computer transmits, based on a command by a gesture of a user acquired via a user device, information about a target facility specified in a video captured by the user device, to the user device, or an output device existing in a predetermined range from a position of the user device, the target facility being specified based on the state of the user in the three-dimensional space or the state, in the three-dimensional space, of the user device moving with the user.

5. A non-transitory storage medium storing a program for causing a computer to transmit, based on a command by a gesture of a user acquired via a user device, information about a target facility specified in a video captured by the user device, to the user device, or an output device existing in a predetermined range from a position of the user device, the target facility being specified based on the state of the user in the three-dimensional space or the state, in the three-dimensional space, of the user device moving with the user.
